(19) United States
(12) Patent Application Publication
(10) Pub. No.: US 2017/0295917 A1
(43) Pub. Date: Oct. 19, 2017

(54) MULTI-FUNCTIONAL PAINT BRUSH TOOL ACCESSORY

(71) Applicant: DERRICH PATRICK RYAN, SHERMAN OAKS, CA (US)

(72) Inventor: DERRICH PATRICK RYAN, SHERMAN OAKS, CA (US)

(21) Appl. No.: 15/133,160

(22) Filed: Apr. 19, 2016

(51) Int. Cl. A46B 15/00; B25G 3/36; B25C 11/00; B25B 15/00; B08B 1/00; B66F 15/00; A46B 17/08

(52) U.S. Cl. CPC A46B 15/0081; B66F 15/00; B25G 3/36; A46B 17/08; B25B 15/00; B08B 1/005; B25C 11/00

(57) ABSTRACT

Some embodiments of the present disclosure include a tool configured to attach to a handle, the tool being multifunctional. The tool may include a housing having a closed end and an open end, the open end defining a cavity sized to accommodate a handle; and a tool end extending from the closed end of the housing, wherein the tool end includes at least one scraper, a nail puller, and a screwdriver.

### BACKGROUND

The embodiments herein relate generally to tools, and more particularly, to a multi-functional tool accessory configured to attach to a paint brush handle.

When an individual is painting, he or she is often required to have multiple tools, such as the paint brush, a scraper, a screwdriver, a nail puller, and the like. Holding and working with multiple tools at once can be difficult and inconvenient.

Therefore, what is needed is a tool accessory that can removably attach to practically any paintbrush handle, enabling a user to have easy access to multiple tools at once.

### SUMMARY

Some embodiments of the present disclosure include a tool configured to attach to a handle, the tool being multifunctional. The tool may include a housing having a closed end and an open end, the open end defining a cavity sized to accommodate a handle; and a tool end extending from the closed end of the housing, wherein the tool end includes at least one scraper, a nail puller, and a screwdriver.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present disclosure.

FIG. 2 is a left perspective view of one embodiment of the present disclosure.

FIG. 3 is a right perspective view of one embodiment of the present disclosure.

FIG. 4 is an exploded view of one embodiment of the present disclosure.

FIG. 5 is a section view of one embodiment of the present disclosure, taken along line 5-5 in FIG. 1.

FIG. 6 is a top view of one embodiment of the present disclosure.

FIG. 7 is a front view of one embodiment of the present disclosure.

FIG. 8 is a back view of one embodiment of the present disclosure.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a multi-tool accessory for a paint brush handle and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Tool

2. Handle Cavity

3. Fasteners

The various elements of the device of the present disclosure may be related in the following exemplary fashion. It is not intended to limit the scope or nature of the relationships between the various elements and the following examples are presented as illustrative examples only.

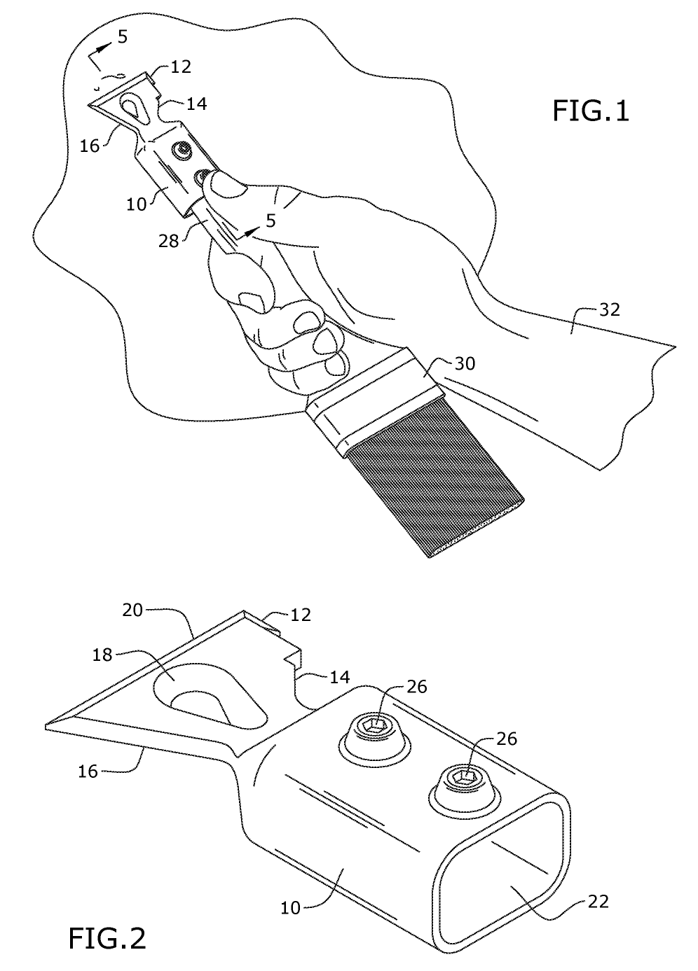

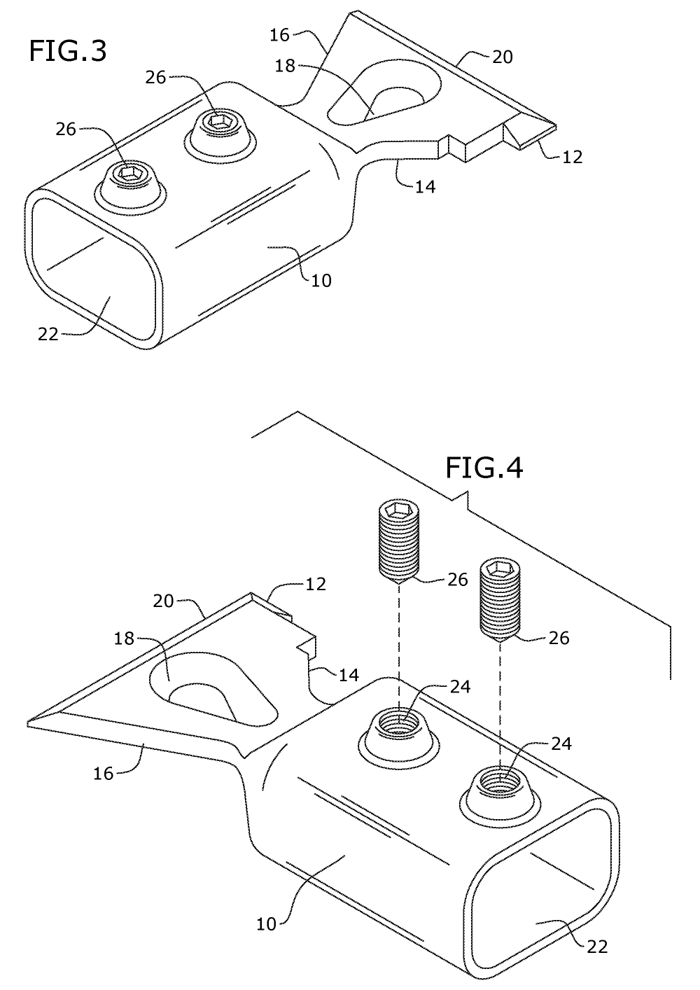

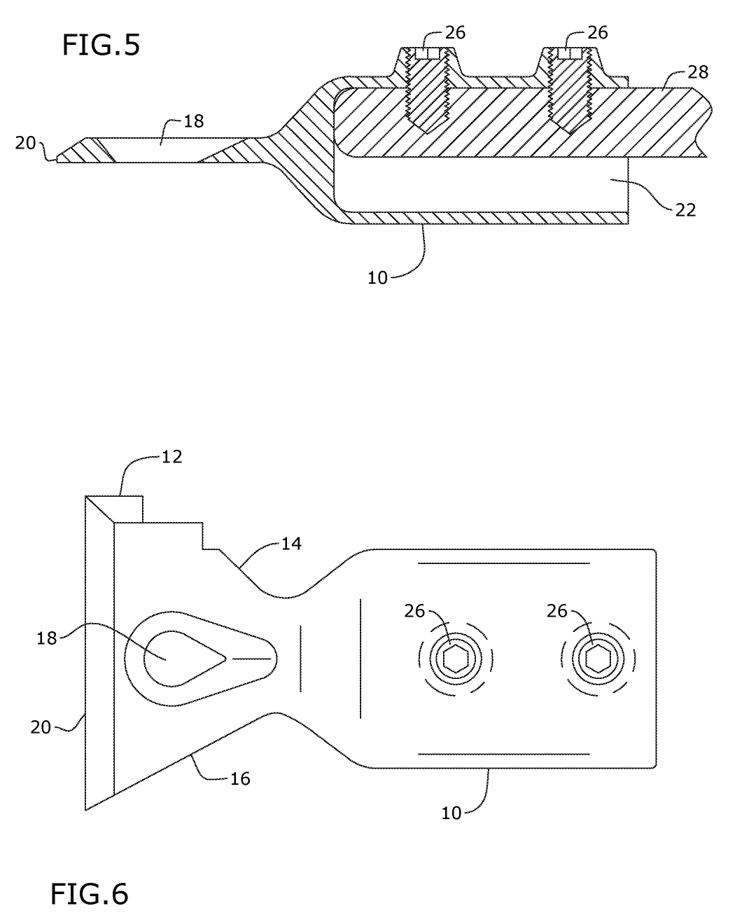

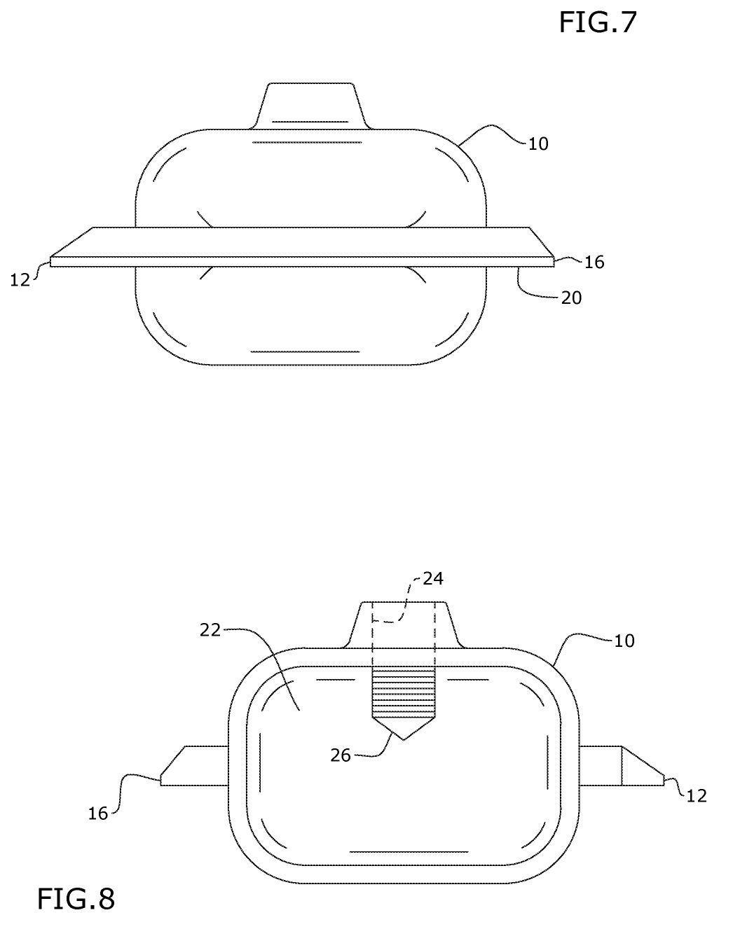

By way of example, and referring to FIGS. 1-8, some embodiments of the present disclosure include a tool configured to attach to a handle 28, such as a paintbrush handle, the tool comprising a housing 10 having a closed end and an open end, the open end defining a cavity 22 sized to accommodate a handle 28, such as a paintbrush handle, a tool end extending from the closed end of the housing 10, wherein the tool end comprises at least one scraper, a nail puller 18, and a screwdriver 12. In some embodiments, such as those shown in the Figures, the tool end is substantially triangularly shaped, wherein a left side scraper 16 extends outwardly from the closed end of the housing 10, the left side scraper 16 angled away from a central portion of the tool; a right side scraper 14 extends outwardly and diagonally away from a central portion of the tool; and a front scraper 20 connecting the left side scraper 16 and the right side scraper 14, such that the front scraper 20 may be perpendicular and planar to the orientation of the handle 28. In embodiments, the tool end may be a solid piece, wherein the scrapers 14, 16, 20 define the outer edges of the tool end, and a central portion of the tool end comprises a nail puller 18. In embodiments, the nail puller 18 may comprise an orifice with tapered sides, similar to a conventional nail puller.

As shown in the Figures, the front scraper 20 and the left side scraper 16 may taper downwards, such that the edges of the tool end are slanted. The right side scraper 14 may be similarly shaped. However, in alternate embodiments, the right side scraper 14 may comprise squared off edges with a portion of the right side scraper adjacent to the front scraper 20 comprising a screwdriver 12 with angled edges, similar to the front scraper 20 and the left side scraper 16.

The housing 10 may be configured to accommodate a handle 28, as described above and as shown in the Figures. In some embodiments, the handle 28 may slide into the cavity 22. The handle 28 may then be attached to the housing 10 using at least one fastener. For example, in some embodiments, the housing 10 may comprise at least one screw hole 24 through which screws 26 may extend and attach to the handle 28. In embodiments, the screws 26 may comprise Allen key screws. While the Figures show the fasteners as screws, the use of any conventional fastener is envisioned. In a further embodiment, the handle 28 may fit snugly within the cavity 22 such that no fasteners are necessary to secure the tool to the handle 28.

To use the tool of the present disclosure, a user 32 may insert an end of the handle 28 opposite the brush 30 into the cavity 22. When desired or necessary, the user 32 may secure the housing 10 to the handle 28 using the fastener, such as a pair of screws 26. The user 32 may then use the paintbrush as normal, while simultaneously having easy access to the tool, which includes structures for scraping, nail pulling, screwdriving, and, potentially, cutting.

The tool of the present disclosure may be made from any desired materials and, in some embodiments, comprises plastic, metal, wood, a combination thereof, or the like.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A tool configured to attach to a handle, the tool comprising:
a housing having a closed end and an open end, the open end defining a cavity sized to accommodate a handle; and
a tool end extending from the closed end of the housing,
wherein the tool end comprises at least one scraper, a nail puller, and a screwdriver.

2. The tool of claim 1, wherein the tool end is substantially triangularly shaped.

3. The tool of claim 2, wherein:
a left side scraper extends outwardly from the closed end of the housing, the left side scraper angled away from a central portion of the tool;
a right side scraper extends outwardly from the closed end of the housing, the right side scraper angled away from the central portion of the tool; and
a front scraper connects the left side scraper and the right side scraper.

4. The tool of claim 3, wherein:
the tool end is a solid piece; and
the left side scraper, the right side scraper, and the front scraper define outer edges of the tool end.

5. The tool of claim 4, wherein a central portion of the tool end comprises the nail puller.

6. The tool of claim 5, wherein the nail puller comprises an orifice with angled edges.

7. The tool of claim 3, wherein the front scraper and the left side scraper taper downwards, resulting in the tool end having at least two angled edges.

8. The tool of claim 3, wherein the right side scraper comprises squared off edges other than a section of the right side scraper adjacent to the front scraper, the section comprising a screwdriver with angled edges.

9. The tool of claim 1, wherein the housing comprises a pair of screw holes.

10. The tool of claim 9, wherein the tool further comprises a pair of screws, each of the screws configured to extend through a respective screw hole to attach the housing to the handle.
